(19) United States
(12) Patent Application Publication
(10) Pub. No.: US 2009/0196976 A1
(43) Pub. Date: Aug. 6, 2009

(54) NOVEL USE OF CAPSAICIN

(76) Inventors: Szilvia Levaine Papp., Szeged (HU); Judit Papp, Szeged (HU); Attila Zoltai, Szeged (HU)

Correspondence Address: MILLER THOMPSON, LLP, Scotia Plaza, 40 King Street West, Suite 5800, TORONTO, ON, M5H 3S1, CA

(21) Appl. No.: 12/306,369

(22) PCT Filed: Jun. 29, 2007
(86) PCT No.: PCT/HU2007/000058

§ 371 Date: Jan. 19, 2009

(30) Foreign Application Priority Data
Jun. 30, 2006 (HU) P0600551

(51) Int. Cl. A23L 1/221

(52) U.S. Cl. 426/615

(57) ABSTRACT

The invention concerns a new application of capsaicin found in peppers. More precisely, the invention is based on a system with the help of which capsaicin present in peppers is introduced into foodstuff that is suitable for human consumption, for example water, mineral water, fruit juices, dairy products or wines. The invention also deals with the process that introduces capsaicin into foods, as well as with the capsaicin-containing products produced this way.

### FIELD OF INVENTION

This invention relates in general to the field the a functional food product and the process for manufacturing said functional food.

### BACKGROUND OF THE INVENTION

Capsaicin and capsaicin-containing preparations are applied in medicine even today. These preparations are used to stimulate appetite or—in the form of ointments—to treat rheumatic diseases, lumbago, chilblain. They have also been included in hair grower and anti-hairfall preparations.

The physiological effects of capsaicin are much more diverse. Its effects in connection with ulcers were unclear for a long time and it is widely known that those suffering from ulcers were advised against consuming spicy foods and hot peppers.

It was Szolcsányi and Barthó who first demonstrated in rats that low-concentration capsaicin introduced into the stomach inhibits or totally prevents the development of gastric ulcer and that only sensory nerve ending blockage due to high concentrations leads to the development of more severe ulcers (Szolcsányi, J. and Barthó, L. Adv. Physiol. Sci., 1981, 15: 39-51). Further studies widely supported this gastric ulcer preventing effect of capsaicin (Holzer, P. and Sarnetz, W. Gastroenterology 1986, 91: 975-981; Evangelista, S., Maggi, C. A., and Meli, A. Proc. Soc. Exp. Biol. Med. 1987, 184: 264-266; Holzer et al. Am. J. Physiol. 1991, 260 G363-370; Maggi, C. A. Prog. Neurobiol. 1995, 45: 1-98; Mózsik, Gy., Abdel-Salam, O. M. E., Szolcsányi, J. Capsaicin-sensitive afferent nerves in gastric mucosal damage and protection Akadémiai Kiadó Budapest 1997; Szolcsányi, J. and Barthó, L. J. Physiol. (Paris) 2001, 95: 181-188).

The reason for this favourable effect is the fact that capsaicin administer orally increases blood perfusion in gastric and intestinal mucosa and stimulates intestinal peristalsis due to vasoactive peptides released from sensory nerve endings. Capsaicin also dilates cutaneous blood vessels, increases heat release and thrombosis-inhibiting effects have been reported as well.

Proving that introducing capsaicin into the stomach of healthy volunteers protects the gastric mucosa and prevents indomethacin-induced gastric bleeding and alcohol-induced mucosal damage was a very significant achievement (Mózsik, Gy., Szolcsányi, J. and Rácz, J., World J. Gastroenterology 2005, 11: 5180-5184).

In animal models capsaicin inhibits the oxidation of low-density lipoproteins (Kempaiah et al, Mol. Cell. Biochem. 2005, 275: 7-13), protects the integrity of red blood cells in rats consuming fatty foods and suffering from hypercholesterolemia (Kempaiah, RK and Srinivasan, K. J. Nutr. Biochem. 2006, 17: 471-478) and prevents the development of hypercholesterolemia (Negulescu, J. A. et al, Artery, 1989, 16: 174-188). In humans the prolonged consumption of hot peppers inhibits the oxidation of serum lipoproteins (Ahuja, K. D. and Ball, M. J. Br. J. Nutr. 2006, 96: 239-242).

In animal models the stimulation of capsaicin-sensitive nerves decreases hypertension, inhibits reperfusion-induced liver damage, endotoxin-induced shock and stress-induced damage to the gastric mucosa (Okajéma, K. and Harado, N. Curr. Med. Chem. 2006, 13: 2241-2251).

Capsaicin stimulates metabolism, decreases lipid uptake and inhibits the development of obesity (Westerterp-Plantenaga, M. et al. Physiol. Behav. 2006, 89: 85-91, Int. J. Obes (Lond) 2005 29: 682-688).

Capsaicin inhibits the proliferation and growth of different malignant cells, including carcinoma cells in the prostate (Mori, A. et al, Cancer Res. 2006, 66: 3222-3229) and in vitro it kills human gastric adenocatcinoma cells (Lo, YC. et al, World J3 Gastroenterol. 2005, 11: 6254-7). At present there is no data concerning either carcinogenic or carcinoprotective effects of long-term capsaicin consumption in vivo.

There are many papers nowadays giving information of the various applications of capsaicin or peppers. The following provides an overview of some of these papers and the essential differences between those solutions and the present invention.

A Japanese patent (nr. JP 2000189121) describes a capsaicin-containing drink which has very favourable calorie content and which can increase body temperature. The desired effect is achieved by adding hot spices to the drink. In one presentation of the invention 0.0000015-0.0005 mass percent of capsaicin is used as hot spice. One considerable disadvantage of it is that the unpleasant, hot taste cannot be eliminated and apart from the small increase in body temperature other physiological effects cannot be achieved due to the minimal amount of capsaicin.

A Dutch patent (nr. NL 9202104) describes a pepper drink that contains water, pepper juice and/or pepper extract and at least one kind of sweetener. According to the invention, the most favourable form of presentation contains pepper juice and/or pepper purée (made of 3-4 red peppers), a litre of water, three tablespoons of cane sugar and one teaspoon of honey. The invention also includes the procedure of producing the drink. During the procedure pimiento is used as the starting material of pepper juice. Pimiento; however, contains only a negligible amount of capsaicin, so the inventors did not realise the opportunities inherent in the compound or the importance of applying it on its own.

A Japanese patent (nr. JP 2002186469) describes a health-preserving dietetic drink that contains mannan gel, capsaicin, water, jellifying agents, sweeteners and other additives. The resulting drink can decrease the fat content of the body thereby preventing obesity. The inventors; however, could not solve one of the most serious problems in connection with capsaicin, i.e. they could not introduce relatively big amounts of capsaicin into an exclusively watery medium in a way that the resulting solution will be stable.

A Chinese patent (nr. CN 152 0751) describes a Chinese medicine that contains pepper as one of its active agents. The medicine can be used by itself or added to other drinks and it can treat various gastric and intestinal complaints. However, the patent does not realise the increased advantages of applying capsaicin on its own, nor does it solve the stabilisation of capsaicin in a watery medium or the elimination of its hot taste.

A Chinese patent (nr. CN 1337243) describes a carcinoprotective herbal tea that contains pepper as one of its active agents. The procedure of production can be altered so that not only tea, but powder, tablets, capsules wine, beer, syrup, sweets or biscuits can be produced. However, this paper does not describe the essential physiological effects of capsaicin, its application as a sole component or its introduction into a watery medium in a relatively big amount.

A Hungarian patent announcement published on 30 Aug. 1993. (nr. P9101963) describes a natural colouring and taste agent made of seasoning pepper or pimiento. The extracted starting materials can be used to produce soft and alcoholic drinks, salads and pickles, which can be diluted with water. The paper does not describe capsaicin or its stable watery solutions.

A Hungarian patent (nr. 204984) describes a procedure to produce alcohol-free fruit and vegetable products. However, the document and its claims do not give details on peppers or capsaicin.

A Japanese patent (nr. JP 2001190251) describes a procedure to produce a fermented soft drink. Among several other substances, the soft drink contains sweet pepper as well. However, the patent does not mention capsaicin or its application in watery solutions.

A Japanese patent (nr. JP 2001190252) describes a soft drink that can trigger immune responses and that may contain sweet pepper extract besides several other substances and has no acidic taste. The document does not mention capsaicin, the elimination of its hot effects or its application in watery solutions.

A Russian patent (nr. RU 2160548) describes an alcohol-free hot drink that contains ground red pepper seeds as an additive for taste enhancement. The document does not mention capsaicin or its effects.

A Russian patent (nr. RU 2219233) describes a bitter liqueur. Besides several other substances, the liqueur may contain watery-alcoholic red pepper extract. The document does not mention capsaicin or its applicability.

An American patent (nr. US 2003/0091719 A1) published on 15 May, 2003 describes a healthy soft drink, one ingredient of which may be pepper. However, neither the description nor the claims of the patent mention capsaicin.

As it is obvious from what is said above, so far mostly pepper extracts and pepper drinks have been used to introduce capsaicin into the human body. These products either could not be considered stimulants or they had such a peculiar taste that they were consumed only by a limited group of people.

### SUMMARY OF THE INVENTION

In one aspect the present invention is **

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DETAILED DESCRIPTION OF THE PREFERRED EMBODIMENT

This novel invention concerns a new application of capsaicin found in peppers. More precisely, the invention is based on a system with the help of which capsaicin present in peppers is introduced into foodstuff that is suitable for human consumption, for example water, mineral water, fruit juices, dairy products or wines. Our invention focuses on a system with the help of which much more pepper-derived capsaicin could be introduced in foodstuff suitable for human consumption than the amount realised with prior technological knowledge. The invention also deals with the process that introduces capsaicin into foods, as well as with the capsaicin-containing products produced this way.

Capsaicin itself is a characteristically spicy, hot substance that strongly irritates the sensory nerve endings in the oral mucosa and the tongue root when it gets in the oral cavity. However, because of its favourable physiological effects, it is advisable to introduce capsaicin as a low-concentration capsaicin as possible into the organism.

One very important aspect of the invention is that capsaicin, the sensory stimulant responsible for the hotness of peppers, causes an unpleasant burning sensation in the mouth only in high concentrations. In the range of its threshold concentration, it produces a pleasant, warm sensation. One of the most important characteristics of the sensory nerve stimulating effect of capsaicin is that in cold fluids neither burning nor hot sensation occurs; however, if the temperature of the mucosa increases, the characteristic hot or burning sensation soon develops depending on the concentration. By cooling the oral mucosa with water of room temperature, sensory effects can be blocked any time.

When talking about the most important properties and advantages of the invention, it is very important to emphasise that an embodiment of the invention may include a procedure to introduce capsaicin into watery solutions. It is a very significant result, as no stable capsaicin-containing watery solutions have been available before.

A benefit of the present invention over the prior art is that it may fulfil a need for techniques that could eliminate the unpleasant taste of capsaicin, so that this substance with very important physiological effects can be incorporated in fluids that are widely consumed in big amounts such as water, mineral water, dairy products, fruit juices and wines.

As a result, an aim of the present invention is to provide a new procedure and products that eliminate the drawbacks of the prior art products and methods. An additional aims of the present invention are to introduce capsaicin into new products and increase its amount in older ones without the person who ingests such products experiencing an increased unpleasant hot taste.

In accordance with embodiments of the present invention, these aims may be achieved by applying a special method to introduce capsaicin into foodstuff. This method may include the use of fulvic acid-chelate complex and L-ascorbic acid besides capsaicin. The chelate complex may contain iron, chromium or selenium cations. The ‘system’ may also contain other additive substances that enhance taste. For example, in one embodiment of the present invention menthol may be applied to improve taste. A skilled reader will recognize that other taste-enhancing substances may also be used instead of menthol, for example, such as orange oil, lemon, eucalyptus oil with lemon, strawberry aroma or the mixture of these. Another embodiment of the present invention may contain smoke aroma on its own or combined with other taste enhancers. One significant advantage of the application of smoke aroma is that it decreases nicotine-cravings in the person who consumes the product, so smoke aroma-containing products can be used effectively in facilitating giving up smoking. The amount of the specific substances can be found in the examples and in the claims.

The products produced by the procedure described in the invention have essential physiological effects. For example, if chromium cations are applied in the chelate complex, a product may be produced that has a beneficial effect on the carbohydrate metabolism of the body and also on the regulation of glucose homeostasis, which means it can play an important role in the nutrition of diabetic patients.

Another important advantage of the invention is that with the help of the trace elements that can be found in the system which is used to introduce capsaicin it may be possible to achieve a very favourable effect on the whole organism as well as increase vitality. A couple of seconds after the consumption of the present invention product warmth can be felt, which is evidence of the product's vasodilating effect.

In accordance with embodiments of the present invention, when introducing capsaicin into foods, it is possible to blend the substances and add the appropriate amount of the resulting mixture to the foods.

Appropriate feeding equipment may be used to introduce capsaicin into foods, for example, such as water, mineral water, fruit juices, dairy products or wines. Such feeding equipment is well-known for experts and it has been used in the food industry for a long time. It is important to note that capsaicin can only be introduced into dairy products in the form of solution. In such cases the amount of ingredients has to be determined in relation to the average body weight of consumers. In this manner a stock solution may be produced that contains the ingredients and has the smallest possible volume that can keep the components in the solution. For example, the body weight of an average adult may be understood to be approximately 75 kg, while that of an average child may be approximately 40 kg. A skilled reader will recognize that the system of the present invention may be capable of being introduced into other foods as well.

The active agents may be produced in the form of tablets as well. For this purpose the previously mentioned mixture of the active agents may be mixed with binders and other excipients used in the process of the tablet production and then pressed with the appropriate pharmaceutical equipment. The tablets may be produced in a way that they readily dissolve in the appropriate medium, for example, such as water, mineral water, fruit juices, thereby releasing the active agents and making them available for the organism of the consumer. A skilled reader will recognize the range of binders, excipients and technological equipment that may be used in the production of tablets in accordance with the present invention.

### EXAMPLES

The following examples introduce the invention in more detail. A skilled reader will recognize that in the following embodiments of the invention are illustrated by way of example. It is to be expressly understood that the description is only for the purpose of illustration and as an aid to understanding, and is not intended as a definition of the limits of the invention.

### Example 1

An embodiment of the present invention may involve a system of the following composition that may be used to introduce capsaicin into foods:

| | | |
|---|---|---|
| Capsacinoids | 0.1-10 | mg/l |
| Iron (II) fulvic acid chelate | 6-30 | mg/l |
| L-menthol | 1-100 | mg/l |
| L-ascorbic acid | 1-100 | mg/l |
| Sodium fluoride | 0.7-1.2 | mg/l |
| Zinc fulvic acid chelate | 3-10 | mg/l |

During the production the starting materials present in the form of solid powder may be mixed with each other, then the resulting mixture may be homogenised. The produced mixture can immediately be introduced into foods.

### Example 2

An embodiment of the present invention may involve a system of the following composition that may be used to introduce capsaicin into foods:

| | | |
|---|---|---|
| Capsacinoids | 0.1-10 | mg/l |
| Selenium fulvic acid chelate | 4-265 | microgram/l |
| L-menthol | 1-100 | mg/l |
| L-ascorbic acid | 1-100 | mg/l |
| Sodium fluoride | 0.7-1.2 | mg/l |
| Zinc fulvic acid chelate | 3-10 | mg/l |

During the production the starting materials present in the form of solid powder may be mixed with each other, then the resulting mixture may be homogenised. The produced mixture can immediately be introduced into foods.

### Example 3

An embodiment of the present invention may involve a system of the following composition that may be used to introduce capsaicin into foods:

| | | |
|---|---|---|
| Capsacinoids | 0.1-10 | mg/l |
| Chromium fulvic acid chelate | 3-30 | microgram/l |
| L-menthol | 1-100 | mg/l |
| L-ascorbic acid | 1-100 | mg/l |
| Sodium fluoride | 0.7-12 | mg/l |
| Zinc fulvic acid chelate | 3-10 | mg/l |

During the production the starting materials present in the form of solid powder may be mixed with each other, then the resulting mixture may be homogenised. The produced mixture can immediately be introduced into foods.

### Example 4

### Producing Tablets

From the systems capable of introducing capsaicin into foods and described in Examples 1-3 tablets of 0.5-1.5 g may be produced by blending the powder-form mixture of active agents with binders and other excipients normally used in tablet production and then forming the appropriate shape with the help of a tabletting machine.

A skilled reader will recognize that the given weight of the tablet only serves as an example, and that tablets with a different weight may also be produced. Additionally, a skilled reader will recognize that the form of the tablet may also be varied, and that any generally applied form is acceptable.

### Example 5

### Introducing the System into Foods

An embodiment of the present invention may involve mixing 0.1-10 mg of capsaicin, 6-30 mg of iron (II) fulvic acid-chelate, 1-100 mg of L-menthol, 1-100 mg of L-ascorbic acid, 0.7-1.2 mg of sodium fluoride and 3-10 mg of zinc fulvic acid chelate in an appropriate dish. The mixture may be homogenised then added to 1,000 ml of water, resulting in a solution which is suitable for human consumption.

A skilled reader will recognize that any form (e.g., for example, such as, solution, solid form, powder or tablet) of any embodiment of the present invention described in the above examples can be applied to introduce capsaicin into foods and also that the food can be any of the above mentioned ones, With the exception of dairy products, in which case only the solution form can be applied.

We claim:

1. A capsaicin food product, comprising a composition incorporating substances including: capsacinoids, a chelate complex, L-ascorbic acid, sodium fluoride, and zinc fulvic acid chelate; and wherein the substances are mixed to form the composition and said composition may be combined with a food to form the capsaicin food product.

2. The capsaicin Food product of claim 1 wherein the chelate complex includes one of: iron (II) fulvic acid chelate; selenium fulvic acid chelate; or chromium fulvic acid chelate.

3. The capsaicin food product of claim 2 wherein the substances include:
a. 0.1-10 mg/l of capsacinoids;
b. the chelate complex is one of the following: 6-30 mg/l of iron (II) fulvic acid chelate, 4-265 microgram/l of selenium fulvic acid chelate, or 3-30 microgram/l of chromium fulvic acid chelate;
c. 1-100 mg/l of L-ascorbic acid;
d. 0.7-1.2 mg/l of sodium fluoride; and
e. 3-10 mg/l of zinc fulvic acid chelate.

4. The capsaicin food product of claim 1 wherein the composition includes a flavour additive.

5. The capsaicin food product of claim 4 wherein the flavour additive is in the amount of 1-100 mg/l.

6. The capsaicin food product of claim 4 wherein the flavour additive may be one or more of the following substances: orange oil, lemon, eucalyptus oil with lemon, strawberry aroma, or smoke aroma.

7. The capsaicin food product of claim 1 wherein the composition is a solution.

8. The capsaicin food product of claim 1 wherein the composition is a tablet, solid or powder.

9. The capsaicin food product of claim 1 wherein the food may be one of: water, mineral water, fruit juice, dairy product or wine.

10. A process for introducing capsaicin into foods, comprising the steps of:
a. mixing substances to form a composition, said substances including capsacinoids, a chelate complex, L-ascorbic acid, sodium fluoride, and zinc fulvic acid chelate; and
b. combining the composition with a food to form a capsaicin food product.

11. The process of claim 10, comprising the further step of:
a. combining the composition with the food that is one of water, mineral water, fruit juice, dairy product or wine.

12. The process of claim 11, comprising the further step of:
a. utilizing a solution form of the composition to combine the composition with the dairy product.

13. The process of claim 10 comprising the further step of mixing a flavour additive into the composition, wherein the flavour additive may be one or more of the following substances: orange oil, lemon, eucalyptus oil with lemon, strawberry aroma, or smoke aroma.

14. A composition for introducing capsaicin into foods comprising a mixture of substances including:
a. 0.1-10 mg/l of capsacinoids;
b. a chelate complex;
c. 1-100 mg/l of L-ascorbic acid;
d. 0.7-1.2 mg/l of sodium fluoride; and
e. 3-10 mg/l of zinc fulvic acid chelate.

15. The composition of claim 14 wherein the chelate complex is one of the following: 6-30 mg/l of iron (II) fulvic acid chelate, 4-265 microgram/l of selenium fulvic acid chelate, or 3-30 microgram/l of chromium fulvic acid chelate.

16. The composition of claim 14 wherein the mixture of substances further includes a flavour additive.

17. The composition of claim 16 wherein the flavour additive is in the amount of 1-100 mg/l.

18. The composition of claim 16 wherein the flavour additive may be one or more of the following substances: orange oil, lemon, eucalyptus oil with lemon, strawberry aroma, or smoke aroma.

19. The composition of claim 14 wherein the composition is a solution, tablet, solid or powder.
